(19) United States
(12) Patent Application Publication
(10) Pub. No.: US 2020/0242123 A1
(43) Pub. Date: Jul. 30, 2020

(54) METHOD AND SYSTEM FOR IMPROVING RELEVANCY AND RANKING OF SEARCH RESULT FROM INDEX-BASED SEARCH

(71) Applicant: Wipro Limited, Bangalore (IN)

(72) Inventors: Raghavendra Rao Venkoba, Bangalore (IN); Suraj Vantigodi, Dharwad (IN); Cyrus Andre Dsouza, Siolim (IN); Manu Kuchhal, Gurgaon (IN)

(21) Appl. No.: 16/352,513

(22) Filed: Mar. 13, 2019

(30) Foreign Application Priority Data
Jan. 29, 2019 (IN) 201941003553

(51) Int. Cl. G06F 16/2457; G06F 16/2455; G06F 16/248

(52) U.S. Cl. CPC G06F 16/24578; G06F 16/248; G06F 16/24553

(57) ABSTRACT

This disclosure relates to method and system for improving relevancy and ranking of a search result from an index-based search for a given search query. The method may include accessing a number of documents of the search result. Each of the documents may be associated with a number of document natural language (NL) feature metadata, a number of document indexing metadata, and at least one document class. The method may further include determining at least one query class, a number of query NL feature metadata, and a number of query indexing metadata for the given search query. The method may further include determining at least one of a relevancy and a ranking of each of the documents using a set of pre-defined rules, and presenting an updated search result based on the at least one of the relevancy and the ranking of each of the documents.

This application claims the benefit of Indian Patent Application Serial No. 201941003553 filed Jan. 29, 2019, which is hereby incorporated by reference in its entirety.

### FIELD

This disclosure relates generally to information retrieval, and more particularly to method and system for improving relevancy and ranking of a search result from an index-based search.

### BACKGROUND

Index-based search systems generally use indexing process for collecting, parsing and storing data in a database for subsequent use by the search engine. The search system may store the collected data in an index so that when the user enters a search query, the search engine refers the index to provide a search result in response to search query. As will be appreciated, the search result may include a reference to a number of documents that matches the search query. The reference may be in form of a page that is stored within the index. Further, as will be appreciated, if indexing functionality was not available with the search engine, the searching process may take considerable amount of time and effort each time a search was initiate for a search query. This may be largely because the search engine would have to search a lot including every web page or piece of data associated with the keywords used in the search query. Searching through a large number of documents may limit the quality of search.

However, index based search systems often fail to yield quality search results because they mostly rely on keywords. The search results provided by conventional index-based search systems are mostly based on a number of keywords or tokens that match between the documents ingested by the search engine (i.e., information stored in the database of the search engine) and the user query and weights of the matched keywords or token. Typically, the conventional index-based search systems provide equal weightage or importance to all keywords irrespective of the content of query. This further affects the accuracy of search results in terms of their relevancy and ranking. For example, irrespective of context or content of a search query, the index-based search system may return search result even if none of the important tokens are matching and some of non-important tokens are matching. Thus, the search result may not be accurate.

### SUMMARY

In one embodiment, a method for improving relevancy and ranking of a search result from an index-based search, is disclosed. In one example, the method may include accessing a plurality of documents of a search result from an index-based search for a given search query. Each of the plurality of documents may be associated with a plurality of document natural language (NL) feature metadata, a plurality of document indexing metadata, and at least one document class. The method may further include determining at least one query class, a plurality of query NL feature metadata, and a plurality of query indexing metadata for the given search query. The method may further include determining at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules. The method may further include presenting an updated search result based on the at least one of the relevancy and the ranking of each of the plurality of documents.

In one embodiment, a system for improving relevancy and ranking of a search result from an index-based search, is disclosed. In one example, the system may include a search improvement device, which may include at least one processor and a computer-readable medium coupled to the processor. The computer-readable medium may store processor executable instructions, which when executed may cause the least one processor to access a plurality of documents of a search result from an index-based search for a given search query. Each of the plurality of documents may be associated with a plurality of document NL feature metadata, a plurality of document indexing metadata, and at least one document class. The processor executable instructions, on execution, may further cause the least one processor to determine at least one query class, a plurality of query NL feature metadata, and a plurality of query indexing metadata for the given search query. The processor executable instructions, on execution, may further cause the least one processor to determine at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules. The processor executable instructions, on execution, may further cause the least one processor to present an updated search result based on the at least one of the relevancy and the ranking of each of the plurality of documents.

In one embodiment, a non-transitory computer-readable medium storing computer-executable instructions for improving relevancy and ranking of a search result from an index-based search, is disclosed. In one example, the stored instructions, when executed by a processor, may cause the processor to perform operations including accessing a plurality of documents of a search result from an index-based search for a given search query. Each of the plurality of documents may be associated with a plurality of document NL feature metadata, a plurality of document indexing metadata, and at least one document class. The operations may further include determining at least one query class, a plurality of query NL feature metadata, and a plurality of query indexing metadata for the given search query. The operations may further include determining at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules. The operations may further include presenting an updated search result based on the at least one of the relevancy and the ranking of each of the plurality of documents.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for improving relevancy and ranking of a search result from an index-based search, in accordance with some embodiments of the present disclosure.

FIG. 2 is a functional block diagram of the exemplary system of FIG. 1, in accordance with some embodiments of the present disclosure.

FIG. 3 is a functional block diagram of an ensemble, rank, and filter (ERF) module for improving relevancy and ranking of a search result from an index-based search, in accordance with some embodiments of the present disclosure.

FIG. 4 is a flow diagram of an exemplary process for improving relevancy and ranking of a search result from an index-based search, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

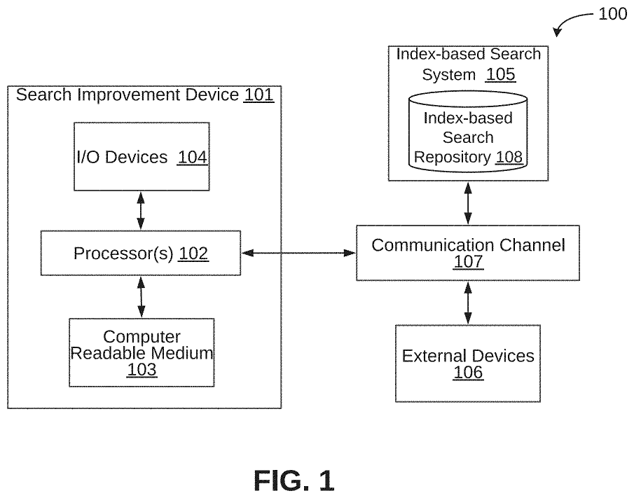

Referring now to FIG. 1, an exemplary system 100 for improving relevancy and ranking of a search result from an index-based search is illustrated, in accordance with some embodiments of the present disclosure. In particular, the system 100 may include a search improvement device 101 for improving relevancy and ranking of a search result from an index-based search. The search improvement device 101 may improve relevancy and ranking of the search result retrieved from the index-based search using natural language processing (NLP).

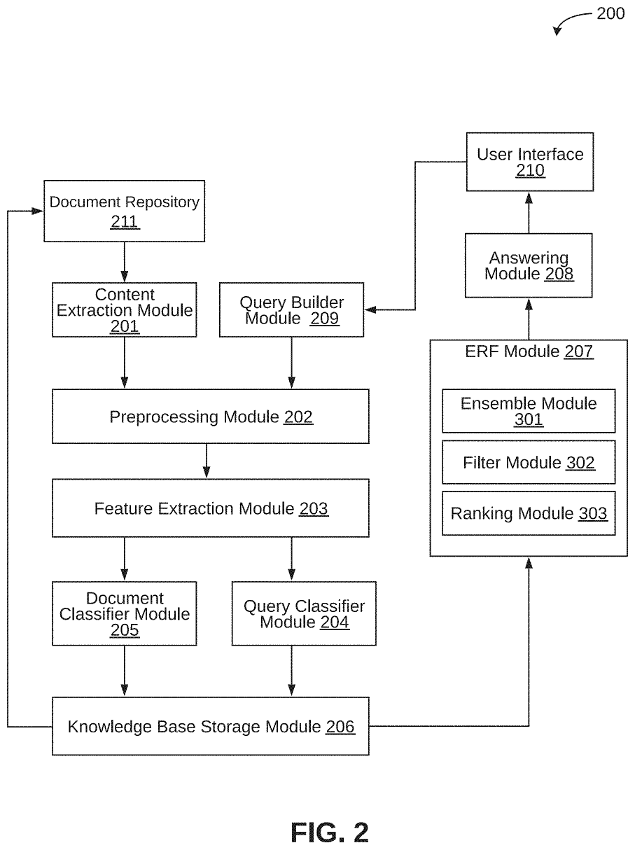

As will be described in greater detail in conjunction with FIGS. 2-5, the search improvement device 101 may access a plurality of documents of a search result from an index-based search for a given search query. It may be noted that each of the plurality of documents may be associated with a plurality of document natural language (NL) feature metadata, a plurality of document indexing metadata, and at least one document class. The search improvement device 101 may further determine at least one query class, a plurality of query NL feature metadata, and a plurality of query indexing metadata for the given search query. The search improvement device 101 may further determine at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules. The search improvement device 101 may further present an updated search result based on the at least one of the relevancy and the ranking of each of the plurality of documents.

The search improvement device 101 may include, but may not be limited to, server, desktop, laptop, notebook, netbook, smartphone, and mobile phone. In particular, the search improvement device 101 may include one or more processors 102, a computer-readable medium (e.g. a memory) 103, and input/output devices 104. The computer-readable storage medium 103 may store the instructions that, when executed by the processors 102, cause the one or more processors 102 to improve relevancy and ranking of a search result from an index-based search, in accordance with aspects of the present disclosure. The computer-readable storage medium 103 may also store various data (e.g. plurality of documents in a search result, query class data of given query, document class data for each document, query NL feature metadata for the given query, document NL feature metadata for each document, query indexing metadata for the given query, document indexing metadata for each document, set of pre-defined rules, relevant parameters data, relevant group data, irrelevant group data, evaluation data, relevancy and ranking of each document, etc.) that may be captured, processed, and/or required by the search improvement device 101. The search improvement device 101 may interact with a user (not shown) via input/output devices 104. The search improvement device 101 may interact with the index-based search system 105 over a communication network 107 for sending improved or updated search result and receiving original search result. In some embodiments, the search improvement device 101 may receive the search result from the index-based search repository 108 implemented by the index-based search system 105. The search improvement device 101 may further interact with one or more external devices 106 over the communication network 107 for sending and receiving various data (e.g., documents of a search result from an index-based search). The one or more external devices 106 may include, but are not limited to, a remote server, a digital device, or another computing system.

Referring now to FIG. 2, a functional block diagram of a system 200, analogous to the exemplary system 100 of FIG. 1, is illustrated in accordance with some embodiments of the present disclosure. The system 200 may include various modules that perform various functions so as to improve a search result from an index-based search for a given search query. In some embodiments, the system 200 may include a content extraction module 201, a pre-processing module 202, a feature extraction module 203, a query classifier module 204, a document classifier module 205, a knowledge base storage module 206, an ensemble, rank, and filter (ERF) module 207, an answering module 208, and a query builder module 209. In some embodiments, the query builder module 209 and answering module 208 may interact with a user (not shown) by the way of a user interface 210 to receive a query and to present an improved or updated search result to the user. As will be appreciated by those skilled in the art, all such aforementioned modules 201-209 may be represented as a single module or a combination of different modules. Moreover, as will be appreciated by those skilled in the art, each of the modules may reside, in whole or in parts, on one device or multiple devices in communication with each other.

The content extraction module 201 may receive a search result from an index-based search for a given search query. In some embodiments, the search result may include a plurality of documents. In some embodiments, the content extraction module 201 may receive the plurality of documents from a document repository 211. It may be noted that each of the plurality of documents of the search result may be associated with a plurality of document NL feature metadata, a plurality of document indexing metadata, and at least one document class. The content extraction module 201 may extract content information from the plurality of documents of the search result. In some embodiments, the content extraction module 201 may use a custom document parser to extract the content information. It may be noted that the content information may include title, section headers, tables, and images of each of the plurality of documents.

The preprocessing module 202 may receive the content information extracted by the content extraction module 201. The preprocessing module 202 may preprocess the content information to clean the content information. By way of an example, during preprocessing, junk data, such as stop words and special characters may be removed from the content information. The preprocessed content information may then be sent to the feature extraction module 203.

Once the content information is pre-processed, the feature extraction module 203 may extract a plurality of document NL feature metadata from the content information and store the same in the knowledge base storage module 206. It may be understood that the plurality of document NL feature metadata may be obtained from the knowledge base storage module 206 and may then be employed to determine relevancy and ranking of the documents in the search result. In some embodiment, the plurality of document NL feature metadata may include part-of-speech (POS) tags, keywords, phrases, entities, entity relationships, or dependency parse tree objects. In some embodiments, the feature extraction module 203 may generate a feature list of input document.

The feature extraction module 203 may perform various functions in order to extract the plurality of document NL feature metadata from the content information. In some embodiments, the functions may include chunking of text data returned by the document parser (at sentence level) i.e. the content extraction module 201. The functions may further include identifying the POS tags, identifying phrases, identifying dependency parse tree objects (pobj and dobj), identifying entity and relationship, identifying query class. It may be noted that NL features may play an important role in identifying the right answer. The NL features may help in deciding which tokens (content information) should be given more importance to.

By way of an example, for a query “What should he the printer configuration for it to work?”, the feature extraction module may perform the following functions:

Identify nouns: “printer”, “configuration”;

Identify verbs: “work”;

Identify phrases: “printer”, “configuration”;

Identify entities: “printer”;

Parse tree objects: dobj printer, sobj configuration

Identify query class: “Information”

The query classifier module 204 may identify a class of a search query (i.e., query class). In some embodiments, the query classifier module 204 may use machine learning techniques to identify the class of the search query. It may be noted that one or more classes of the search query may be from among a number of pre-defined classes. In some embodiments, the one or more pre-defined classes of the search query may include, but may not be limited to, a description, a definition, an abbreviation, a time, a location, a duration, a procedure, a title, a reason, a person, a number, a problem, and an information. As will be appreciated by those skilled in the art, classifying the query may help in providing improving search result from an index-based search for the given search query, and, hence, better answer a user's search query.

By way of an example, the class for search query “What are the steps for changing?” may be identified as “Procedure”. Similarly, the class for search query “Why do I need to register?” may be identified as “Reason”. In the above examples, the class may be identified based on the words of the phrases “what are the steps” and “why do I need to”, respectively. It may be understood that the query class may help in eliminating wrong answers, i.e. irrelevant documents from the search result.

By way of another example, the class for search query “Why do I reset my password” may be identified as “information”, and the class for search query “How to reset my password” may be identified as “procedure”. It may be understood that both the above queries include same tokens (content), and relate to “reset my password”. However, classes of both the queries are different. As it will be appreciated, index-based searches for such queries may not be able to identify the underlying difference between the two queries, and hence may fail to provide accurate search results.

Similarly, the document classifier module 205 may identify and extract document class of each of the plurality of documents. It may be noted that the document class may be used for determining relevancy and ranking the search result. As with the query class, one or more classes of a document may be from among a number of pre-defined classes including, but not limited to, a description, a definition, an abbreviation, a time, a location, a duration, a procedure, a title, a reason, a person, a number, a problem, and an information. The document classifier module 205 may be communicatively coupled to the knowledge base storage module 206. The document classifier module 205 may communicate with the knowledge base storage module 206 during receiving the plurality of documents and during execution of the query by a user. During receiving the plurality of documents, the extracted content information, the preprocessed content information and original data related to the plurality of documents may be written to a database. In parallel, the data may be written on to an index-based search repository.

The extracted NL features may help in identifying which tokens form the query and the document are important. From the basics of natural language understanding, the system 200 may know that the main tokens in any user query are the noun and verb. The phrases may be also extracted, and which are used to compute phrase match score and applied in the ranking and filtering block.

In some embodiments, the knowledge base storage module 206 may extract document NL feature metadata from the content of the plurality of documents. The document NL feature metadata may include POS tags, phrases, entities and relationships. The knowledge base storage module 206 may further extract other document metadata information including date of creation and author of the document. The document metadata information may further include section information, POS, noun or verb phrases, entities, entity relations, multi-words, synonyms, abbreviations, document class, section class, and concepts.

As will be appreciated, an index-based search may use various techniques, such as Elasticsearch, Solr and Lucene for indexing content of the plurality of documents along with synonyms, and stop-word removal filters.

One of the objectives of the disclosed system 200 is to introduce ways of improving on the normal index-based search systems using NL metadata and classes extracted from the document. As stated above, the disclosed system 200 may extract various NL features metadata from the content of the document as well as classes the document. This data extraction may be performed while ingesting the document for the elastic search.

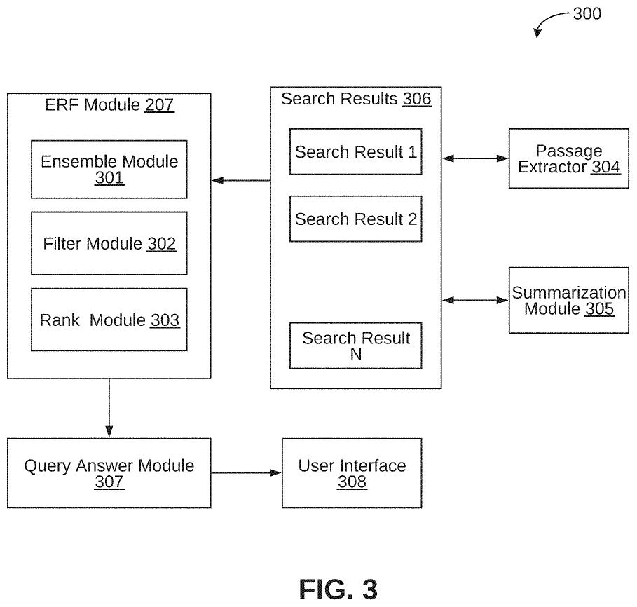

The ERF module 207 may filter and rank documents in the search result. The ERF module 207 is further explained in detail, in conjunction with FIG. 3. Referring now FIG. 3, a functional block diagram of the ERF module 207 for improving relevancy and ranking of a search result from an index-based search is illustrated, in accordance with some embodiments of the present disclosure. The ERF module 207 may include an ensemble module 301, a filter module 302, and a ranking module 303.

The ERF module 207 may retrieve a search result 305 from an index-based search for a given search query from an indexing module (not shown). It may be understood that the indexing module may use indexed data for obtaining search results. In some embodiments, the search result 305 obtained by the indexing module may be first received by a passage extraction module 304 and a text summarization module 305. The passage extraction module 304 and the text summarization module 305 may perform passage extraction and text summarization on the search result to extract relevant text from the answer related to the query.

The ERF module 207 may perform random forest regression on the extracted NL features (i.e., one or more of NL feature metadata) and their ratios to identify important features. The ERF module 207 may further rank and filter the results based on the important NL features or relevant parameters. It should be noted that a relevant parameter may include a combination of important NL features. In some embodiments, the relevant parameter may also include indexing metadata, or class metadata either alone or in combination with the important NL feature metadata. For example, the important NL feature or relevant parameter used by the ERF module 207 may include, but may not be limited to, the following:
Noun match ratio (number of nouns matched between the query and the returned answer to the total number of nouns in the query)
Verb match ratio (number of verbs matched between the query and the returned answer to the total number of verbs in the query)
Adjectives
Noun phrases—1, 2, 3, 4+grams (number of noun phrases matched between the query and the returned answer to the total number of noun phrases in the query)
verb phrases—1, 2, 3, 4+grams (number of verb phrases matched between the query and the returned answer to the total number of verb phrases in the query)
Multi words
Dependency parse tree type terms (check if dependency terms from the query match in the document)
Non-domain terms (count of non-domain terms)
Query class (Boolean to check if query class has matched)
Terms (ratio of terms matched between query and answer to the total terms in the query)
Elastic Search score

In some embodiments, the ERF module 207 may receive the search result from the knowledge base storage module 206. The ERF module 207 may further filter the search result to remove irrelevant documents from the search result. For example, in some embodiments, the ERF module 207 may bucket the given document into a relevant group or an irrelevant group. In some embodiments, the bucketing may be performed by applying a set of pre-defined rules on the set of relevant parameters for the given document. The ERF module 207 may then retain the set of documents belonging to the relevant group, while removing the remaining documents belonging to the irrelevant group. The ERF module 207 may further rank the search result to provide improved search result to a user via a query answer module 307 and a user interface 308. For example, in some embodiments, the ERF module 207 may rank a set of documents bucketed into the relevant group. The ranking may be based on a pre-defined order of priority and a score for each of the set of relevant parameters for each of the set of documents. In other words, the set of documents bucketed into the relevant group may be ranked based on a type of relevant parameter (i.e., type of key features forming the relevant parameter) and score of the relevant parameter (i.e., aggregate score of the key features forming the relevant parameter).

By way of an example, following categories of documents in the search result may be put into valid buckets {(Rules)(Valid)}:
a. Keywords Bases—KW
b. 2,3,4+gram phrases match above a threshold—PM0
c. Noun and Verb phrase match ratio is above a threshold and passage score is above a threshold
d. Passage score, Noun and verb match ratio, DEP match ratio—TH0
e. Passage and ES score above a threshold—all the nouns matched and terms matched and non-domain term match is less than a threshold, if query verb exists than verb match ratio—TH1
f. Passage and ES score above a threshold—all the nouns matched and terms matched and non-domain term match is less than a threshold when no verb identified in query.—TH2
g. Metadata booster b. is above a threshold and noun and verb match is above a threshold—−TH3
h. Metadata booster b. is above a threshold and noun matched and non-domain term match ratio is less than the threshold and RIM score is above threshold—TH4
i. Metadata booster b. is above a threshold and noun matched and non-domain term match ratio is less than the threshold, Metadata booster b. is above a threshold—TH5
j. ES result matched index less than threshold and no non-domain terms matched, all terms matched and noun and verb match ratio above threshold.—TH6
k. ES result matched index less than threshold and no non-domain terms matched, noun and verb match ratio above threshold—TH7
l. Noun and Verb phrase match ratio above threshold and noun match ratio above a threshold and verb match ratio above a threshold—SM0
m. Noun and Verb phrase match ratio above threshold and noun match ratio above a threshold and no query verb phrase identified in query—SM1
n. Matched Deep parse tree terms which is part of domain key dictionary match ratio is above a threshold and matched dep terms match ratio above a threshold—SM2
o. Noun and Verb phrases not identified in query and noun match ratio above a threshold and verb match ratio above a threshold—SM3
p. Noun and Verb phrases not identified in query and noun match ratio above a threshold and no query verb phrase identified in query—SM4

Further, by way of an example, following categories of documents in the search result may be put into invalid buckets {(Rules)(Invalid)}:
a. User query class and Result query class has not matched—N0
b. For non-FAQ document results—which are not part of PM0, PM1, SM0, SM1, SM2, SM3, SM4, TH3 result type passage and deep parse tree type match threshold—N1
c. With query verb found in user query and none of the verbs matched and passage score threshold—N2
d. Results which are not part of PM0, PM1 result type—Noun/verb phrase match ratio is below a threshold and dep parse tree term count is below a threshold—N3
e. Results which are not part of PM0, PM1, SM0, SM1, SM2, SM3, SM4 result type and query class identified for user query and passage score match ratio is less than a threshold—N4
f. Deep parse tree terms match and keywords match is less than threshold—N5

In some embodiments, identifying the thresholds for different result types and their associated priority may be automated. It may be noted that the identifying may be automated based on the test data and the ingested data in the knowledge base storage module 206, by running a script. When result types grouped together can create new valid and invalid result types. Ex: TH0, TH1 individually might be not important as per data ingested and test data so move (suggest) it to the Invalid list. But (TH0, TH1) together can be a valid result type. This information is also captured by the automated script. Prioritizing of the result type groups is also automated, following example shows how the priorities are set. Grouping the result type—Ex: (PM0, TH0, TH1)—To be given higher priority, than other groups for example (PM0) or (PM0, TH0). User feedback can be used to identify Valid and Invalid Result type and groups over time.

In some embodiments, the ERF module 207 may periodically analyze the search result. The ERF module 207 may then fine-tune the pre-defined rules and associated thresholds (e.g., rules for determining relevancy or bucketing, rules for ranking, associated thresholds) so as to further refine relevancy and ranking of the search result. It should be noted that, in some embodiments, the fine-tuning of the pre-defined rules may be performed manually or automatically using a machine-learning model. It may be noted that the fine-tuning may vary from case to case, depending on the type of documents received (i.e., knowledge being ingested) and user feedback received on the search result. Further, it should be noted that the thresholds and pre-defined rules may be modified, deleted or generated afresh.

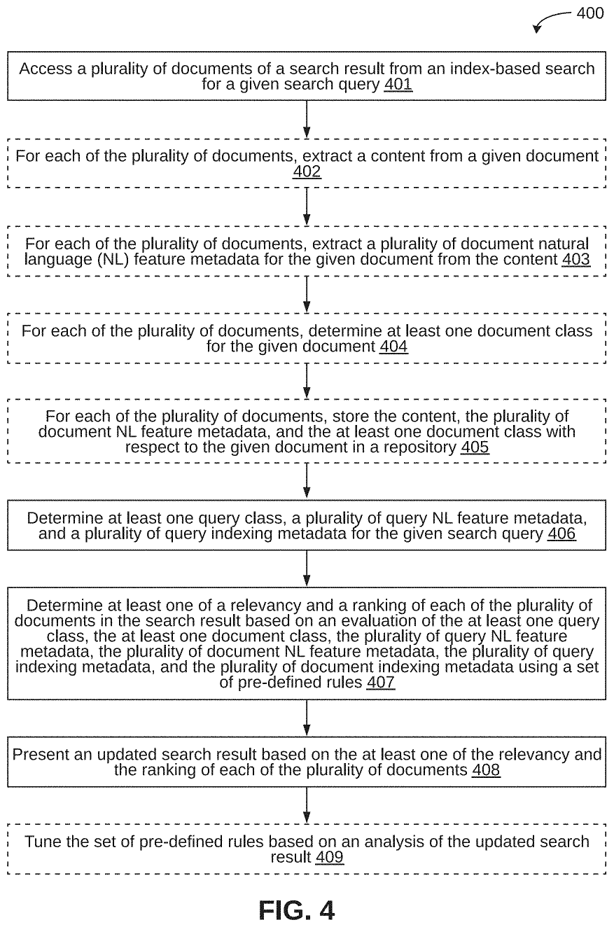

Referring now to FIG. 4, an exemplary process 400 for improving relevancy and ranking of a search result from an index-based search is depicted via a flowchart, in accordance with some embodiments of the present disclosure. At step 401, the search improvement device 200 may access a plurality of documents of the search result from the index-based search for a given query. It may be noted that each of the plurality of documents may be associated with a plurality of document NL feature metadata, a plurality of document indexing metadata, and at least one document class. The extraction of the plurality of document NL feature metadata and the at least one document class may be explained in greater detail with respect to steps 402-405. At step 406, the search improvement device 200 may determine at least one query class, a plurality of query NL feature metadata, and a plurality of query indexing metadata for the given query search. At step 407, the search improvement device 200 may determine at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules. At step 408, the search improvement device 200 may present an updated search result based on the at least one of the relevancy and the ranking of each of the plurality of documents. In some embodiments, at step 409, the search improvement device 200 may tune the set of pre-defined rules based on an analysis of the updated search result.

Additionally, in some embodiments, at step 402, the search improvement device 200 may extract a content from a given document, for each of the plurality of documents. At step 403, the search improvement device 200 may extract the plurality of document NL feature metadata for the given document from the content of the given document, for each of the plurality of documents. At step 404, the search improvement device 200 may determine at least one document class for the given document, for each of the plurality of documents. At step 405, the search improvement device 200 may store the content, the plurality of document NL feature metadata, and the at least one document class with respect to the given document in a repository, for each of the plurality of documents.

It may be noted that the plurality of document NL feature metadata or the plurality of query NL feature metadata may include, but may not be limited to, part-of-speech (POS) tags, phrases, entities, entity relationships, or dependency parse tree objects. It may be further noted that the plurality of document indexing metadata or the plurality of query indexing metadata may include, but may not be limited to, keywords, synonyms, abbreviations, a date of creation, or an author. It may be further noted that the at least one query class or the at least one document class may include, but may not be limited to, an abbreviation, a duration, a procedure, a title, a reason, a person, a location, a time, a number, a problem, an information, a description, or a definition.

In some embodiments, the evaluation performed by the search improvement device 200 at step 407 may include determining a set of relevant parameters, from among a plurality of parameters, for a given document that are indicative of the at least one of the relevancy and the ranking of the given document. It may be noted that the set of relevant parameters may include, but may not be limited to, a noun match ratio, a verb match ratio, adjectives, multi-words, a noun phrase match ratio, a verb phrase match ratio, a keywords match ratio, a phrase match ratio, dependency keywords, a count of non-domain keywords, a passage score, an elastic search score, or a combination thereof.

In some embodiments, determining the relevancy of the given document may include bucketing the given document into one of a relevant group and an irrelevant group by applying the set of pre-defined rules on the set of relevant parameters for the given document. In some embodiments, determining the ranking of the given document may include ranking a set of documents bucketed into the relevant group, based on a pre-defined order of priority and a score for each of the set of relevant parameters for each of the set of documents.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of #52396476 v computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

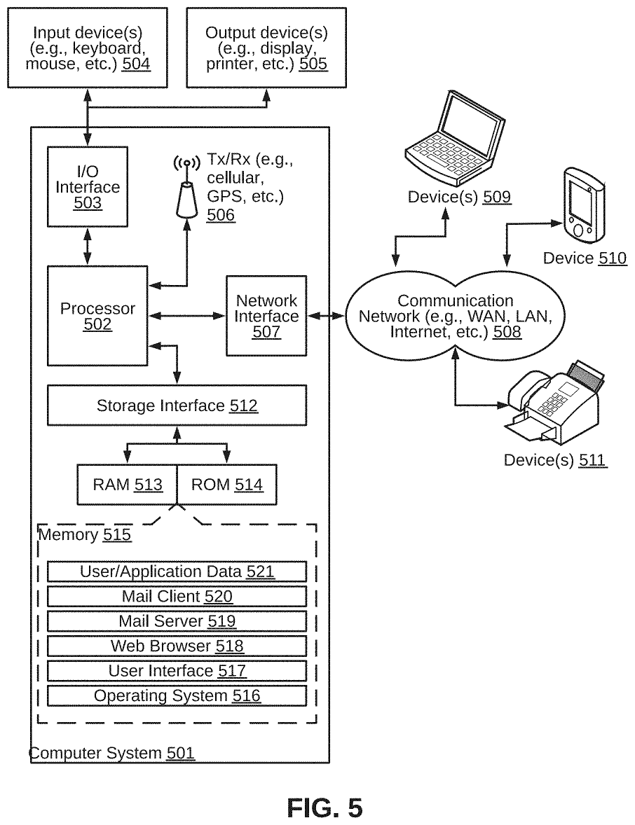

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 for improving relevancy and ranking of a search result from an index-based search. Computer system 501 may include a central processing unit (“CPU” or “processor”) 502. Processor 502 may include at least one data processor for executing program components for executing user-generated or system-generated requests. A user may include a person, a person using a device such as such as those included in this disclosure, or such a device itself. The processor 502 may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver 506 may facilitate various types of wireless transmission or reception. For example, the transceiver 506 may include an antenna operatively connected to a transceiver chip (e.g., TEXAS INSTRUMENTS® WILINK WL1283®, BROADCOM® BCM4750IUB8®, INFINEON TECHNOLOGIES' X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface 507 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices 509, 510, and 511 may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK®, etc.), laptop computers, notebooks, gaming consoles (MICROSOFT® XBOX®, NINTENDO® DS®, SONY® PLAYSTATION®, etc.), or the like. In some embodiments, the computer system 501 may itself embody one or more of these devices.

In some embodiments, the processor 502 may be disposed in communication with one or more memory devices 515 (e.g., RAM 513, ROM 514, etc.) via a storage interface 512. The storage interface 512 may connect to memory devices 515 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 515 may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems 516 include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 517 may facilitate display, execution, interaction, manipulation, or operation of program components through textual or graphical facilities. For example, user interfaces 517 may provide computer interaction interface elements on a display system operatively connected to the computer system 501, such as cursors, icons, check boxes, menus, scrollers, windows, widgets, etc. Graphical user interfaces (GUIs) may be employed, including, without limitation, APPLE® MACINTOSH® operating systems' AQUA®, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 501 may implement a web browser 518 stored program component. The web browser 518 may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers 518 may utilize facilities such as AJAX®, DHTML, ADOBE® FLASH®, JAVASCRIPT®, JAVA®, application programming interfaces (APIs), etc. In some embodiments, the computer system 501 may implement a mail server 519 stored program component. The mail server 519 may be an Internet mail server such as MICROSOFT® EXCHANGE®, or the like. The mail server 519 may utilize facilities such as ASP, ActiveX, ANSI C++/C #, MICROSOFT .NET®, CGI scripts, JAVA®, JAVASCRIPT®, PERL®, PHP®, PYTHON®, WebObjects, etc. The mail server 519 may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 501 may implement a mail client 520 stored program component. The mail client 520 may be a mail viewing application, such as APPLE MAIL®, MICROSOFT ENTOURAGE®, MICROSOFT OUTLOOK®, MOZILLA THUNDERBIRD®, etc.

In some embodiments, computer system 501 may store user/application data 521, such as the data, variables, records, etc. (e.g., plurality of documents in a search result, query class data of given query, document class data for each document, query NL feature metadata for the given query, document NL feature metadata for each document, query indexing metadata for the given query, document indexing metadata for each document, set of pre-defined rules, relevant parameters data, relevant group data, irrelevant group data, evaluation data, relevancy and ranking of each document, etc.) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide for improving relevancy and ranking of a search result from an index-based search for a given search query. In particular, the techniques provide for an intelligent system that allows for improving relevancy and ranking of the search result from the index-based search using natural language processing (NLP). The techniques further use indexed metadata involving part-of-speech (POS) tags and synonyms for assigning weightage to important words/phrases. Accordingly, the techniques provide for an improved ranking over the ranking provided by the index-based search. The ranking is based on various features which include phrase matching between a user query and a result returned by the index-based search, entity and relationship matching, query class matching between the user query and the results returned, along with the query tokens and the answer tokens matching. As such, by using additional metadata, the techniques help in improving accuracy of the results returned by the index-based search system, and in better filtering and ranking of the returned results based on the above-mentioned features.

The specification has described method and system for improving relevancy and ranking of a search result from an index-based search. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of improving relevancy and ranking of a search result from an index-based search, the method comprising:
accessing, by a search improvement device, a plurality of documents of a search result from an index-based search for a given search query, wherein each of the plurality of documents is associated with a plurality of document natural language (NL) feature metadata, a plurality of document indexing metadata, and at least one document class;
determining, by the search improvement device, at least one query class, a plurality of query NL feature metadata, and a plurality of query indexing metadata for the given search query;
determining, by the search improvement device, at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules; and
presenting, by the search improvement device, an updated search result based on the at least one of the relevancy and the ranking of each of the plurality of documents.

2. The method of claim 1, wherein the plurality of document NL feature metadata or the plurality of query NL feature metadata comprise at least one of POS tags, phrases, entities, entity relationships, or dependency parse tree objects.

3. The method of claim 1, wherein the plurality of document indexing metadata or the plurality of query indexing metadata comprise at least one of keywords, synonyms, abbreviations, a date of creation, or an author.

4. The method of claim 1, wherein the at least one query class or the at least one document class comprises at least one of an abbreviation, a duration, a procedure, a title, a reason, a person, a location, a time, a number, a problem, an information, a description, or a definition.

5. The method of claim 1, further comprising:
receiving the plurality of documents; and
for each of the plurality of documents,
extracting a content from a given document;
extracting the plurality of document NL feature metadata from the content;
determining the at least one document class for the given document; and
storing the content, the plurality of document NL feature metadata, and the at least one document class with respect to the given document in a repository.

6. The method of claim 1, wherein the evaluation comprises determining a set of relevant parameters, from among a plurality of parameters, for a given document that are indicative of the at least one of the relevancy and the ranking of the given document.

7. The method of claim 6, wherein the set of relevant parameters comprises at least one of a noun match ratio, a verb match ratio, adjectives, multi-words, a noun phrase match ratio, a verb phrase match ratio, a keywords match ratio, a phrase match ratio, dependency keywords, a count of non-domain keywords, a passage score, an elastic search score, or a combination thereof.

8. The method of claim 6, wherein determining the relevancy of the given document comprises bucketing the given document into one of a relevant group and an irrelevant group by applying the set of pre-defined rules on the set of relevant parameters for the given document.

9. The method of claim 8, wherein determining the ranking of the given document comprises ranking a set of documents bucketed into the relevant group, based on a pre-defined order of priority and a score for each of the set of relevant parameters for each of the set of documents.

10. The method of claim 1, further comprising tuning the set of pre-defined rules based on an analysis of the updated search result.

11. A system of improving relevancy and ranking of a search result from an index-based search, the system comprising:
a search improvement device comprising at least one processor and a computer-readable medium storing instructions that, when executed by the at least one processor, cause the at least one processor to perform operations comprising:
accessing a plurality of documents of a search result from an index-based search for a given search query, wherein each of the plurality of documents is associated with a plurality of document natural language (NL) feature metadata, a plurality of document indexing metadata, and at least one document class;
determining at least one query class, a plurality of query NL feature metadata, and a plurality of query indexing metadata for the given search query;
determining at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules; and
presenting an updated search result based on the at least one of the relevancy and the ranking of each of the plurality of documents.

12. The system of claim 11, wherein the plurality of document NL feature metadata or the plurality of query NL feature metadata comprise at least one of POS tags, phrases, entities, entity relationships, or dependency parse tree objects, wherein the plurality of document indexing metadata or the plurality of query indexing metadata comprise at least one of keywords, synonyms, abbreviations, a date of creation, or an author, and wherein the at least one query class or the at least one document class comprises at least one of an abbreviation, a duration, a procedure, a title, a reason, a person, a location, a time, a number, a problem, an information, a description, or a definition.

13. The system of claim 11, wherein the operations further comprise:
receiving the plurality of documents, and
for each of the plurality of documents,
extracting a content from a given document;
extracting the plurality of document NL feature metadata from the content;
determining the at least one document class for the given document; and
storing the content, the plurality of document NL feature metadata, and the at least one document class with respect to the given document in a repository.

14. The system of claim 11, wherein the evaluation comprises determining a set of relevant parameters, from among a plurality of parameters, for a given document that are indicative of the at least one of the relevancy and the ranking of the given document.

15. The system of claim 14, wherein the set of relevant parameters comprises at least one of a noun match ratio, a verb match ratio, adjectives, multi-words, a noun phrase match ratio, a verb phrase match ratio, a keywords match ratio, a phrase match ratio, dependency keywords, a count of non-domain keywords, a passage score, an elastic search score, or a combination thereof.

16. The system of claim 14, wherein determining the relevancy of the given document comprises bucketing the given document into one of a relevant group and an irrelevant group by applying the set of pre-defined rules on the set of relevant parameters for the given document.

17. The system of claim 16, wherein determining the ranking of the given document comprises ranking a set of documents bucketed into the relevant group, based on a pre-defined order of priority and a score for each of the set of relevant parameters for each of the set of documents.

18. The system of claim 11, wherein the operations further comprise tuning the set of pre-defined rules based on an analysis of the updated search result.

19. A non-transitory computer-readable medium storing computer-executable instructions for:
accessing a plurality of documents of a search result from an index-based search for a given search query, wherein each of the plurality of documents is associated with a plurality of document natural language (NL) feature metadata, a plurality of document indexing metadata, and at least one document class;
determining at least one query class, a plurality of query NL feature metadata, and a plurality of query indexing metadata for the given search query;
determining at least one of a relevancy and a ranking of each of the plurality of documents in the search result based on an evaluation of the at least one query class, the at least one document class, the plurality of query NL feature metadata, the plurality of document NL feature metadata, the plurality of query indexing metadata, and the plurality of document indexing metadata using a set of pre-defined rules; and
presenting an updated search result based on the at least one of the relevancy and the ranking of each of the plurality of documents.
